(19) United States
(12) Patent Application Publication
(10) Pub. No.: US 2015/0007734 A1
(43) Pub. Date: Jan. 8, 2015

(54) BLANC BBQ GRILLING MAT

(71) Applicant: CHARLES GERYESHELIAS BLANC, SR., Hialeah, FL (US)

(72) Inventor: CHARLES GERYESHELIAS BLANC, SR., Hialeah, FL (US)

(21) Appl. No.: 14/495,892

(22) Filed: Sep. 25, 2014

(51) Int. Cl. A47J 37/07

(52) U.S. Cl. CPC A47J 37/0786
USPC 99/645

(57) ABSTRACT

At the present time did not mid any patent listed at Uspto but there is a couple of BBQ mats out that are unsafe and do cause injury

### CROSS REFERENCE TO RELATED APPLICATIONS

This application is not related to any application/s

### FIELD OF THE INVENTION

This invention relates to a present invention

### BACKGROUND OF THE INVENTION

The older and present invention called BBQ grilling mat that is a mat made of Teflon with a flat surface that is placed over a BBQ grill.

### BRIEF SUMMARY OF THE INVENTION

This invention provides and offers a Similar mat but with several holes that helps by draining the oil and fat from the BBQ mat that comes from the food being cooked avoiding spilling and injuring one self when removing the mat for cleaning

### OBJECT OF THE INVENTION

Is to provide easy cooking and cleaning

The same time safety

not causing injury to one self by not having hot fat or oil on the mat standing still

In addition to the old invention this invention has half the mat holes

Most importantly this invention avoids the need to have to worry while taking the mat of the BBQ dripping hot fat or oil on one self and easy to just clean in a sink than clean the BBQ steele which rusts in time causing cancer or the need of replacing

### DETAILED DESCRIPTION OF THE INVENTION

This present invention Blanc BBQ grilling mat that offers a mat with several holes that drains the hot fat and oil from the food and avoids dripping on one self causing injury and cooking a healthy and a better food

### BRIEF DESCRIPTION OF THE SEVERAL VIEWS OF THE DRAWING

FIG. 1 01 is a the Blanc BBQ grilling mat front view in were gives the cooker an option to cook an omelet or an egg etc. 02 is the holes that helps drain the fat deposit and oil from the food when the Blanc BBQ Grilling Mat is placed over the barbeque grill steele the holes provide a gap through for the deposits and grease, fat, oil to drain from the mat

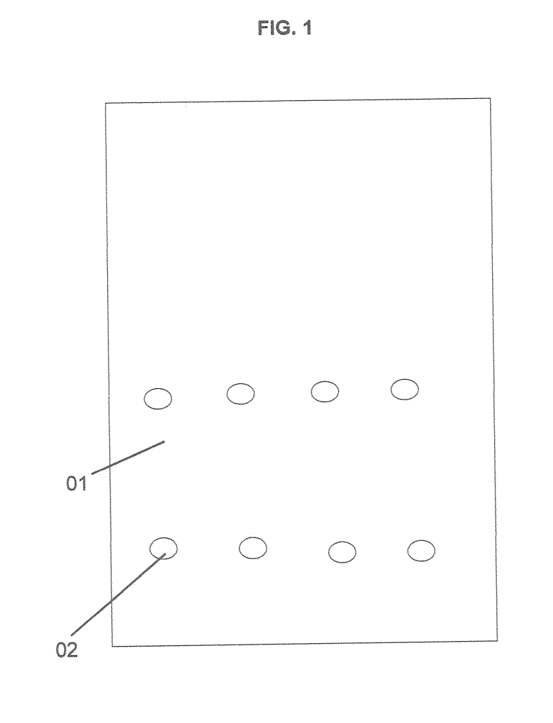

FIG. 2 is the same as figure one except in right view

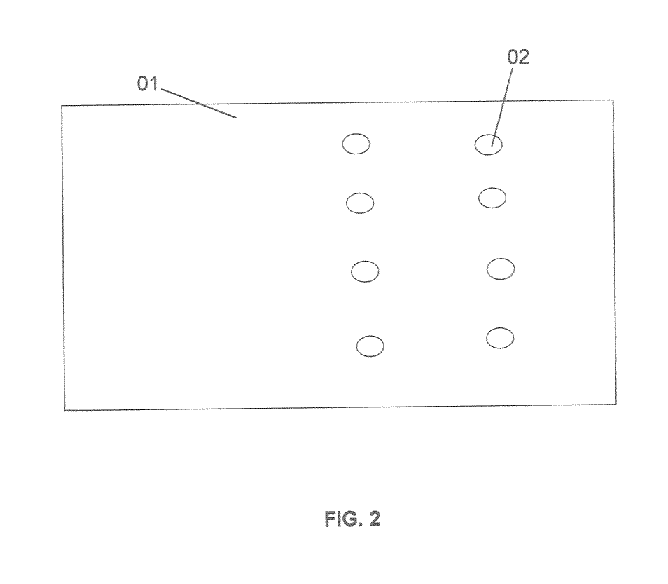

FIG. 3 is the same as figure one except in top view

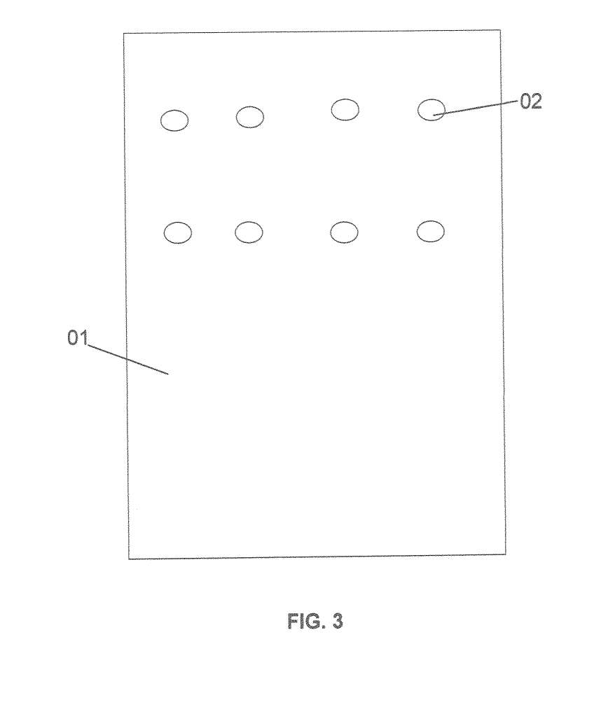

FIG. 4 is the same as figure one except in left view

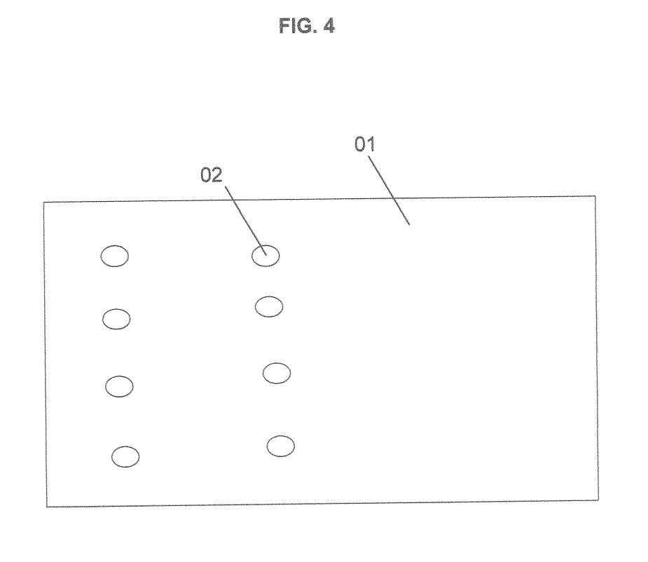

FIG. 5 Is a front view 45 degree showing the BBQ mat

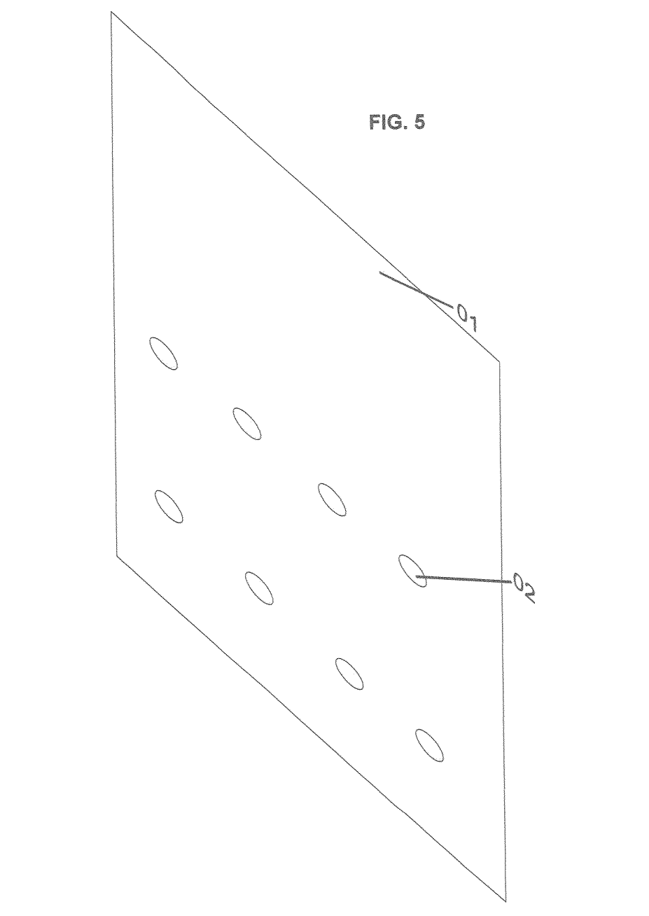

FIG. 6 Is a right view 45 degree showing the BBQ mat

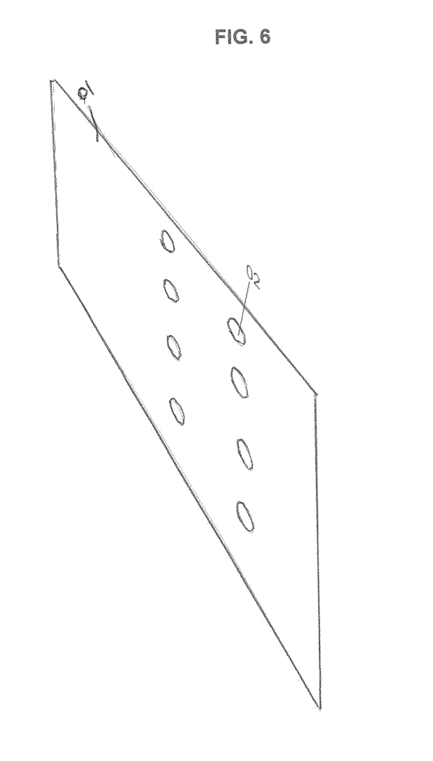

FIG. 7 Is a top view 45 degree showing the BBQ mat

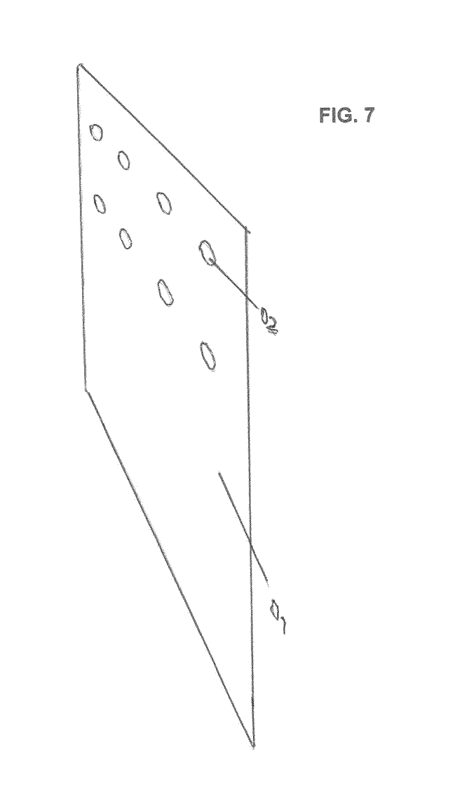

FIG. 8 Is a left view 45 degree showing the BBQ mat

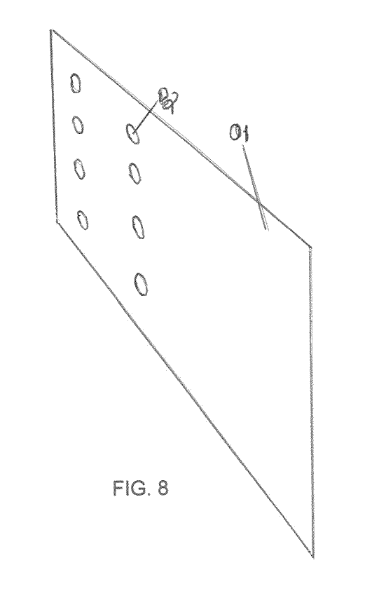

FIG. 9 Is front view showing Sectional & Partial of the mat with and without holes

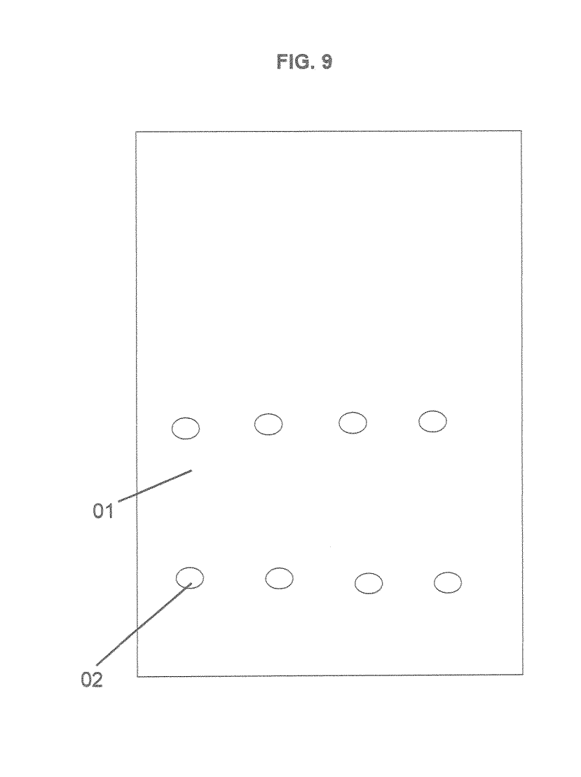

FIG. 10 Is right view showing Sectional & Partial of the mat with and without holes

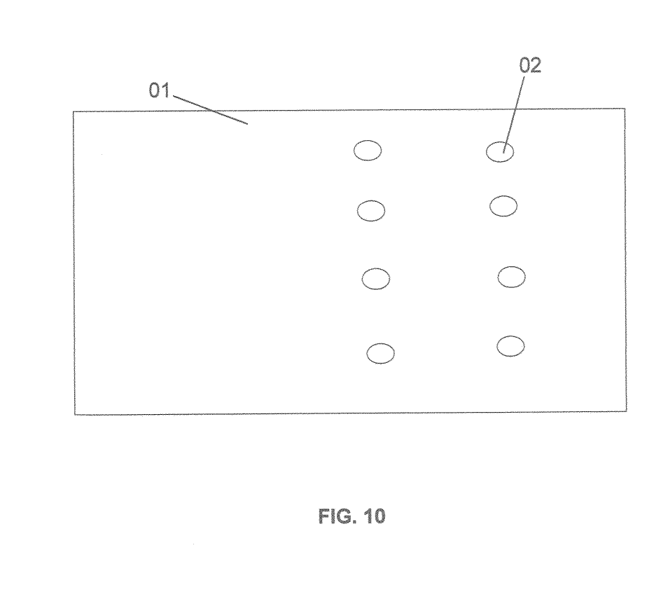

FIG. 11 Is top view showing Sectional & Partial of the mat with and without holes

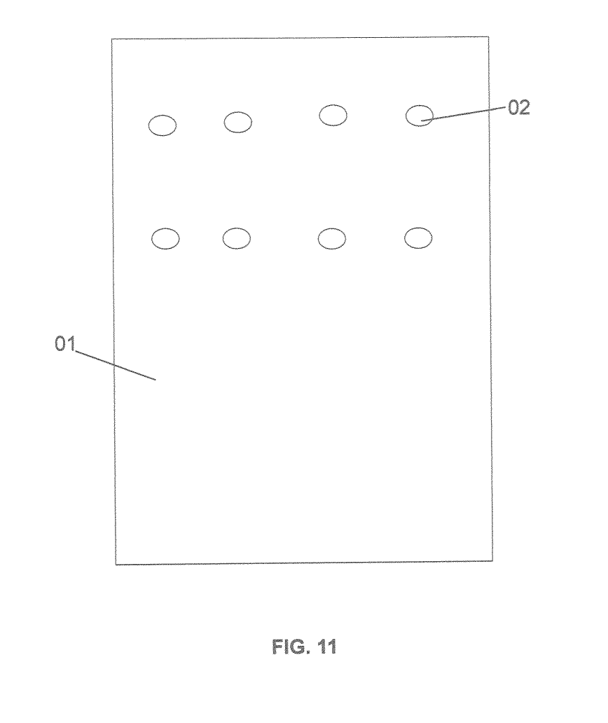

FIG. 12 Is left view showing Sections & Partial of the mat with and without holes

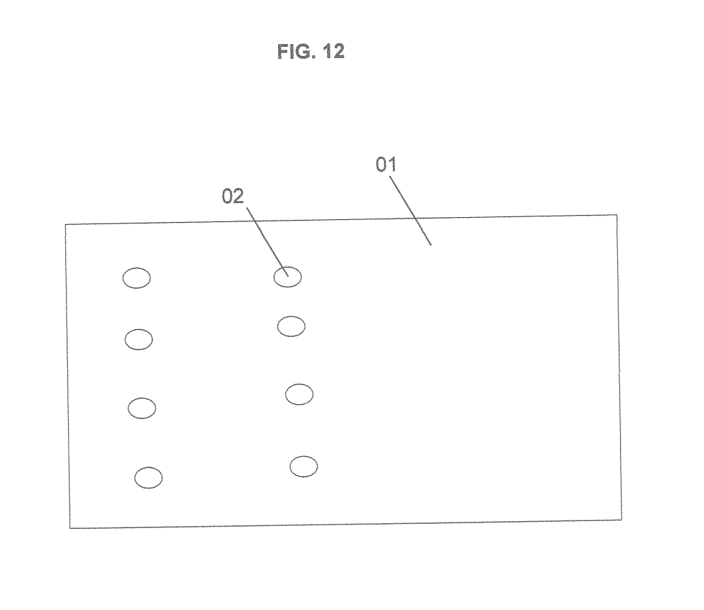

FIG. 13 01 the Grill Mat followed by 02 the holes followed by 03 the deposits oils and fats draining by 02 and 04 is the grill

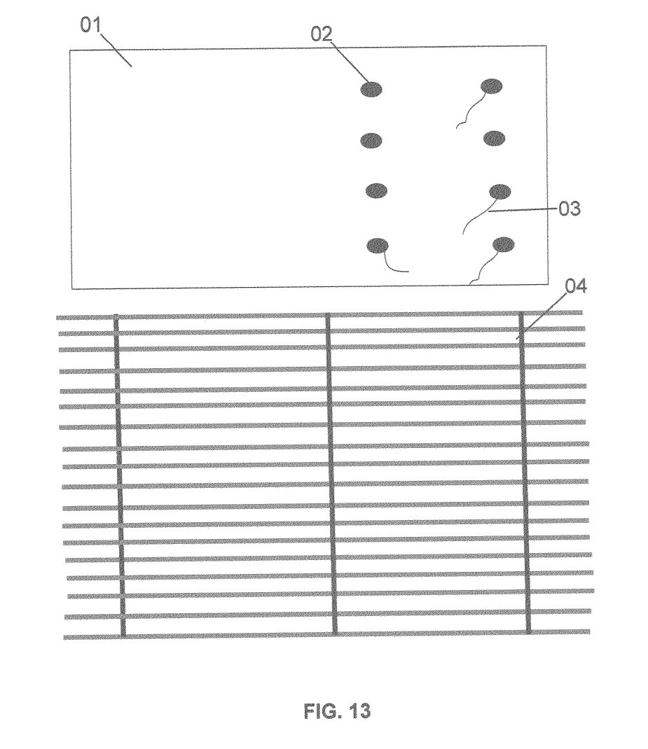

FIG. 14 01 the Mat showing how it sits on 04 the grill followed by 02 the holes 03 the food deposits fats and oils draining over 04 the grill

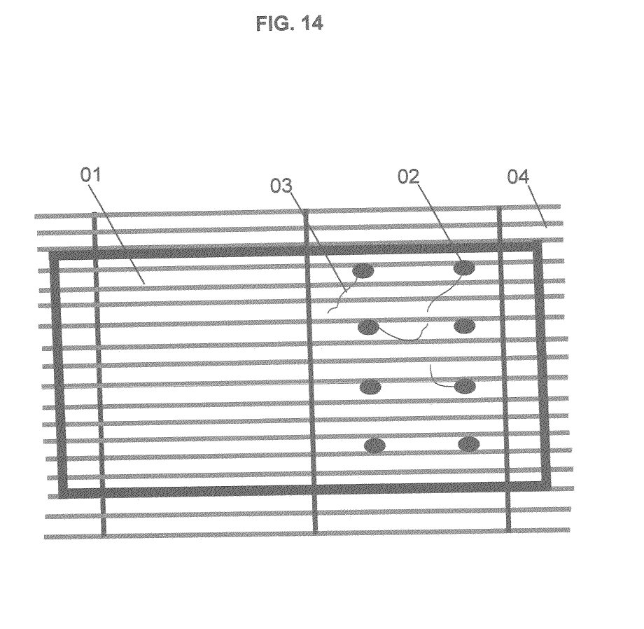

1. This present invention is a BBQ Mat as well as some that are out in the market but what i claim is that Blanc BBQ Grilling Mat comes in with half of the mat having holes for better safety from dripping hot fat and hot oil on one self when trying to remove the BBQ mat from the grill and for a healthy cooking all that fat and oil drains were the food is nicely cooked
